(19) United States
(12) Patent Application Publication
(10) Pub. No.: US 2003/0162113 A1
(43) Pub. Date: Aug. 28, 2003

(54) Inorganic toner and method of producing same

(76) Inventor: Tomiaki Ito, Tagata-gun (JP)

Correspondence Address: RICHARD F. JAWORSKI, Cooper & Dunham LLP, 1185 Avenue of the Americas, New York, NY, 10036, US

(21) Appl. No.: 10/391,276

(22) Filed: Mar. 18, 2003

Related U.S. Application Data
(62) Division of application No. 09/809,981, filed on Mar. 16, 2001.

(30) Foreign Application Priority Data
Mar. 17, 2000 (JP) 2000-076287

(51) Int. Cl. G03G 9/09

(52) U.S. Cl. 430/108.6; 430/110.4; 430/108.1; 430/137.2

(57) ABSTRACT

An inorganic toner composition providing a chromatic color upon being calcined and comprising an inorganic coloring agent, and a binder resin, wherein the content of coarse particles having a diameter of 16 μm or more in said inorganic toner is not greater than 20% by weight. The toner is obtained by kneading a mixture containing an inorganic coloring agent and a binder resin, coarsely pulverizing the kneaded mixture such that the pulverized mixture has a volume average particle diameter of 20-150 μm, finely pulverizing the coarsely pulverized mixture, and sieving the ground mixture.

### BACKGROUND OF THE INVENTION

The present invention relates to an inorganic toner which develops a color when calcined and which contains a coloring agent of an inorganic material and an organic binder resin. The inorganic toner is used for developing an electrostatic image on a photoconductive material, the developed image being transferred to a transfer sheet. The toner image-bearing sheet is used for forming a sintered, mono-colored or full colored pattern on a solid surface such as a tile or a glazed porcelain. The present invention is also directed to a method of producing the above inorganic toner.

To form an image or pattern on the surface of a heat-resistant solid such as ceramics, a desired image or pattern is directly written on the surface of the heat-resistant solid with a brush using a coloring material comprising an inorganic pigment and a glaze, and thereafter the image bearing heat-resistant solid is subjected to firing at 750 to 1,300° C. According to the above-mentioned conventional firing method, some components for use in the coloring material are sintered and the glaze is melted in the course of the firing step, and the inorganic pigment is fixed to the heat-resistant solid surface by the aid of the glaze when cooled to room temperature after sintered. Thus, there remains on the heat-resistant solid surface the image first formed thereon in handwriting.

The above-mentioned firing method has the drawback that the same image or pattern must be formed in handwriting on a plurality of ceramic products only by a skilled craftsman no matter how simple the image or pattern may be. To produce large quantities of ceramic products which bear the same image or pattern thereon, it is therefore proposed that a desired image be first formed on a transfer sheet by screen printing process. The thus formed image-bearing portion is separated from the transfer sheet and attached to the surface of each ceramic product, and then sintered so as to fix the image to the ceramic product.

The above-mentioned fire fixing method using the screen printing process is proposed, for instance, as disclosed in Japanese Laid-Open Patent Application 49-35407. By this kind of fire fixing method, a colored image is formed on a ceramic product in accordance with the following procedure: A transfer sheet comprises a support and a water-soluble paste layer formed thereon. An image is printed by the screen printing process on the above-mentioned water-soluble paste layer of the transfer sheet with an ink comprising an inorganic pigment, and a water-insoluble resin film layer comprising a vinyl or cellulose-based resin is provided on the printed ink image. The image-bearing transfer sheet is immersed into water. The water-soluble paste layer is dissolved in water and the support peels off, whereby there remains an ink-image bearing film member. The ink-image bearing film member thus obtained is applied to the heat-resistant solid surface such as a ceramic plate, and sintered, whereby the sintered image is fixed to the ceramic product. According to this method, a large number of ceramic products that bear the same image thereon can be obtained in such a manner that the same image is printed on many transfer sheets by the screen printing, each of the thus prepared ink-image bearing transfer sheets is attached to the surface of the ceramic product, and the image-bearing ceramic products are sintered. In the screen printing, however, making of a printing plate for forming the ink image includes many steps and requires a great deal of time and labor. The unit cost is necessarily increased, in particular, when various kinds of items are produced, with each item having the same image thereon. Further, the screen printing process is apt to make worse the working conditions due to an air pollution problem caused by the evaporation of organic solvents from the ink employed in the screen printing.

To solve the problems caused by the screen printing process, there is proposed a method of forming a toner image using the electrophotographic process on the same transfer sheet as employed in the above. To be more specific, an image is formed on the transfer sheet using an inorganic toner containing a coloring agent of an inorganic material and an organic binder. In the same manner as stated in the above, the toner image bearing film member is separated from the support of the transfer sheet and attached to a surface of the ceramic product. Then, the toner image thus attached to the ceramic product is sintered, so that the toner image can be easily fixed to the surface of the ceramic product. The aforementioned method is proposed, for example, in Japanese Laid-Open Patent Applications 4-135798, 7-199540, 7-214890, 7-228037, 7-300382, 8-104050, 8-11496 and 8-119668. To improve the color density of a toner for use in the above electrophotographic process, Japanese Laid-Open Patent Application No. H10-246985 discloses a toner whose coloring agent is obtained by fusing two or more metal oxides into an alloy state.

According to the above-mentioned proposed methods using the electrophotographic process, the image formation step can be drastically simplified as compared with that by the screen printing process, and various kinds of items, each item having the same image thereon, can be easily manufactured even though the production of each item is on a small-scale. However, when the toner image-bearing film prepared by the electrophotographic process is applied to the surface of the ceramic product and sintered, there are sometimes caused problems that non-transferred white spots appear in the sintered toner image and the sintered image is impaired by uneven firing.

Such problems are considered to be ascribed to voids existing in toner images. Namely, Japanese Laid-Open Patent Applications No. H11-95481 and No. H11-109675 disclose that air contained in the voids or water entering the voids during separation of the toner image-bearing film from the transfer sheet expands and causes bumping, which results in the formation of white spots or uneven firing. To cope with this problem, Japanese Laid-Open Patent Application No. H11-95481 suggests the use of a toner having a specific amount of charge, while Japanese Laid-Open Patent Application No. H11-109675 suggests the use of a two-component developer composed of a toner and a carrier and having a specific concentration of the toner in the developer. However, these proposed methods are not fully satisfactory.

The conventional inorganic toners have also been found to cause a problem, because the toner contained in a container (e.g. bottle or cartridge) fails to be easily discharged therefrom and to be fed to the image developing zone.

### SUMMARY OF THE INVENTION

The present inventor has investigated properties of inorganic toners with a view toward solving the above problem and found that the formation of voids is attributed to a higher specific gravity of inorganic toners than that of organic toners. Namely, because of higher specific gravity of an inorganic toner, it is more difficult to prepare an inorganic toner having a sharp particle size distribution. It has been found that the known inorganic toner contains relatively coarse particles which cause voids in the toner images. It has also been found that an inorganic toner having a content of coarse particles with a diameter of 16 μm or more of not greater than 20% by weight can prevent the formation of voids which would result in formation of white spots or uneven firing. The present invention is based on this finding.

In accordance with the present invention there is provided in an inorganic toner providing a chromatic color upon being calcined and comprising an inorganic coloring agent, and a binder resin, wherein the content of coarse particles having a diameter of 16 μm or more in the inorganic toner is not greater than 20% by weight.

In another aspect, the present invention provides a method of producing an inorganic toner developing a color when calcined, comprising the steps of:

kneading a mixture containing an inorganic coloring agent and a binder resin,

coarsely pulverizing the kneaded mixture such that the pulverized mixture has a volume average particle diameter of 20-150 μm,

finely pulverizing the coarsely pulverized mixture, and

sieving the ground mixture.

It is an object of the present invention to provide an inorganic toner useful for forming a pattern on a solid surface, such as ceramics, and free of problems such as formation of white spots or uneven firing.

Another object of the present invention is to provide an inorganic toner capable of forming a high grade image which has satisfactory gradient and density and which is free of background stains or image dust (transfer dust).

It is a further object of the present invention to provide an inorganic toner which has good fluidity and which can be fed from a container to a developing zone without troubles.

Other objects, features and advantages of the present invention will become apparent from the detailed description of the preferred embodiments of the invention to follow.

### DETAILED DESCRIPTION OF THE PREFERRED EMBODIMENTS OF THE INVENTION

The content of coarse particles having a diameter of 16 μm or more in the inorganic toner of the present invention is desired to be as low as possible for reasons of minimization of formation of white spots or uneven firing and, thus, is not greater than 20% by weight, preferably not greater than 15% by weight, more preferably not greater than 8% by weight.

It is preferred that the content of fine particles having a diameter of 5 μm or less in the inorganic toner be not greater than 45% by weight, more preferably 5-35% by weight, most preferably 5-15% by weight, for reasons of providing suitable fluidity of the toner and transferability of the toner from its container to a developing zone and also for reasons of freedom of background stains or image dust.

It is also preferred that the inorganic toner have a volume average particle diameter of 3-15 μm, more preferably 5-10 μm, for reasons of satisfactory gradient of toner images.

It is also preferred that the inorganic toner have a ratio, Dv/Dn, of not greater than 1.4, more preferably in the range of 1.1 to 1.3, wherein Dv and Dn represent the volume average particle diameter and number average particle diameter, respectively, of the toner, for reasons of freedom of image dust and white spots.

The characteristics of toner image, such as gradient, image dusts and background stains are common to the toner images before and after the calcination or firing.

The particle size and distribution herein is as measured with the Coulter counter.

The inorganic toner according to the present invention includes a binder resin and a coloring agent having a chromatic color when calcined. Any inorganic coloring agent may be used for the purpose of the present invention as long as it is not converted to an ash or it is not discolored when calcined at a temperature of 450° C. or more.

Examples of suitable inorganic coloring agents include oxides of one or more metals selected from those of Group I in the Periodic Table (e.g. Cu, Ag and Au), Group II (e.g. Cd), Group IV (e.g. Ti), Group V (e.g. V and Sb), Group VI (e.g. Se, Cr, Mo, W and U) Group VII (e.g. Mn) and Group VIII (Fe, Co, Ni, Ir and Pt). These oxides may be used by themselves or as a mixture of two or more thereof. Pigments conventionally employed in the ceramic industry may be used for the purpose of the present invention. However, because of their low color density, it is necessary to use such pigments in a large amount.

For reasons of increased color image density, it is preferred to use, as the coloring agent, a pigment of a material comprising a plural kinds of metal elements which contribute to the color of the coloring agent. Especially suitable pigment may be obtained by fusing a mixture containing a plural kinds of metals which contribute to the color of the coloring agent and/or a plural kinds of metal oxides comprising a plural kinds of metal elements which contribute to the color of the coloring agent at a temperature of 1,000 to 1,200° C., followed by cooling and grinding. Such a pigment is believed to be an alloy pigment rather than a mere mixture in view of analytical results using an electron probe micro analyzer (EPMA).

Illustrative of combination of a plural kinds of metal elements which contribute to the color of the coloring agent are (1) Sb, Fe and Pb, (2) Co, Zn, Al and Cr, (3) Co, Mn, Cr and Fe and (4) Au, Fe and Sn. These alloy pigments have a high absorptivity and give an image with a high color density even used in a small amount. Although not wishing to be bound by the theory, the mechanism of such an increased color density is considered to be splitting of the degenerated d-orbital of the metal by formation of an alloy. The split results in an increase of the number of orbitals to which electron transition can occur and in an increase of the oscillator strength.

It is preferred that the inorganic toner containing the coloring agent (inorganic pigment) additionally contain a glaze frit. A glaze frit-containing inorganic toner may be prepared by use of a mixture of a coloring agent and a glaze frit as such or after the mixture has been fused, cooled and ground.

Especially preferred method includes blending the above-described alloy pigment with a glaze frit, fusing the blend at a temperature of 650 to 800° C., and cooling and grinding the fused blend. The thus obtained coloring agent exhibits high color density owing to the metal pigment and excellent transferability owing to the glaze frit. The frit-containing coloring agent has been found to be a class of an alloy pigment as a result of EPMA analysis. The frit-containing coloring agent is a pigment of a material comprising a plural kinds of metal elements which contribute to the color of said coloring agent, and at least one kind of a metal element which does not contribute to the color of said coloring agent.

By employing the toner comprising the above prepared coloring agent, a clear full-color image with high image density can be formed on the image transfer sheet even though the toner deposition amount is small. When the thus prepared toner-image bearing transfer sheet is attached to the heat-resistant solid surface such as a ceramic product and sintered, a sintered image with high image density can be clearly formed on the heat-resistant solid surface.

In the toner composition, it is preferable that the amount ratio by weight of the coloring agent such as a pigment to the glaze frit be in the range of 2/8 to 6/4, more preferably in the range of 3/5 to 5/5. When the amount ratio of the coloring agent to the glaze frit is within the above-mentioned range, the degree of pigmentation of the toner is sufficient, and the sintered image can be prevented from peeling away from the surface of the heat-resistant solid.

The glaze frit for use in the toner is melted or semi-melted during the sintering step, and thereafter completely solidified when cooled to room temperature, whereby the fritted glaze serves to sinter the coloring agent contained in the toner so as to fix the coloring agent to the heat-resistant solid surface.

Examples of the base material for the glaze frit include a hydroxide of alkali metal or alkaline earth metal, such as lithium hydroxide; a carbonate of alkali metal or alkaline earth metal, such as lithium carbonate; a chloride of alkali metal or alkaline earth metal and aluminum chloride; boric acid and a borate of alkali metal or alkaline earth metal; a metaborate of alkali metal or alkaline earth metal; a phosphate of alkali metal or alkaline earth metal; a pyrophosphate of alkali metal or alkaline earth metal; a silicate of alkali metal or alkaline earth metal; a metasilicate of alkali metal or alkaline earth metal; zirconium silicate; bone ash; borax; ammonium metavanadate; metallic oxides such as tungsten oxide, vanadium pentoxide, tin oxide, zirconium oxide, cerium oxide, and molybdenum oxide; metallic fluorides such as calcium fluoride and aluminum fluoride; and glasslet. These materials can be used alone or in combination.

In order to enhance the bonding between the frit glaze and the pigment, feldspar such as lime feldspar, potash feldspar, soda feldspar or petalite (lithium feldspar), kaolin, silica, alumina, quartz, titanium oxide, chamotte, natural minerals such as earth and ash, limestone, magnesite, talc, and dolomite, barium carbonate, zinc oxide, and strontium carbonate can be employed. These materials may be mixed with the glaze frit and the pigment in advance, and the obtained mixture may be melted, and thereafter added to the toner composition.

The binder may be any thermoplastic resin conventionally used in the field of toner for electrophotography, such as a polyester resin, a polystyrene resin, a polyethylene resin, a polyamide resin, an epoxy resin, an epoxypolol resin, a terpene resin or a mixture thereof. Illustrative of suitable thermoplastic resins are polystyrene, styrene-methyl acrylate copolymers, styrene-ethyl acrylate copolymers and styrene-acrylic acid-n-butyl acrylate copolymers. The binder resin is generally used in an amount of 10-50% by weight based on the weight of the inorganic toner. It is preferred that the amount of the inorganic pigment be greater than the weight of the binder resin for reasons of freedom of background stains, uneven firing and white spots.

The toner for use in the present invention may further comprise a charge control agent. As such a charge control agent, there can be employed any of the conventional charge control agents, for example, nigrosine dyes, quaternary ammonium salts, chromium-containing dyes, zinc-containing dyes, iron-containing dyes, molybdic acid chelate pigments, and fluorine-modified quaternary ammonium salts. These charge control agents may be selected depending upon the polarity of the desired toner. The amount of charge control agent to be added to the toner composition depends upon the kind of thermoplastic resin, the presence or absence of an additive which may be contained in the toner composition when necessary, and also upon the producing method of the toner including the dispersion process. It is proper that the amount of charge control agent be in the range of 0.1 to 10 parts by weight, and more preferably 2 to 6 parts by weight, to 100 parts by weight of the thermoplastic resin. When the amount of charge control agent is within the above-mentioned range, the charge quantity of the toner is sufficient, so that scattering of toner particles and the toner deposition on the background can be prevented. At the same time, the electrostatic attraction of the toner to the carrier is proper, so that the increase in fluidity of the developer can be prevented and the decrease in image density can be reduced.

Also, other conventional additives, for example, an agent for improving the toner fluidity such as hydrophobic silica, zinc stearate, aluminum stearate or titanium oxide, may be added to the toner composition for use in the present invention. The amount of such additives is preferably in the range of 0.3-1.3%, more preferably 0.5-0.8%, based on the weight of the toner for reasons of minimization of white spots and uneven firing.

The toner of the present invention may be used as a single-component-type developing system in which the toner is used by itself for developing an electrostatic latent image or as a two-component-type developing system in which the toner is used in conjunction with carrier particles for developing an electrostatic latent image.

The carrier for use in the two-component-type developing system may be (a) magnetic particles such as of metals, compounds and alloys of iron, cobalt and nickel, (b) glass beads or (c) composite particles composed of the above magnetic particles or glass beads each coated with a layer of a resin. Illustrative of suitable resin for forming the resin coating are polycarbon fluoride, polyvinyl chloride, polyvinylidene chloride, phenol resin, polyvinyl acetal and silicone resin. In the two-component-type system, the toner is generally used in an amount of 5-27% by weight, preferably 7-25% by weight, more preferably 7-15% by weight, based on the weight of the carrier for reasons of minimization of white spots and uneven firing.

The two-component-type developer is packed in a container such as a bottle or a cartridge for sale on the market. Such a container is adapted to be mounted on electrophotographic image forming machines such as copying machines. In the case of a full color image forming machines, four containers respectively containing cyan, magenta, yellow and black toners are mounted on a copying machine.

The inorganic toner according to the present invention may be prepared by a method including a series of steps of kneading a mixture containing an inorganic coloring agent, a binder resin and optionally one or more additives, cooling the kneaded mixture, coarsely pulverizing the cooled mixture, then finely pulverizing the coarsely pulverized mixture, and sieving the finely pulverized mixture. Such steps are similar to those conventionally used for the preparation of organic toners for use in electrophotography. However, when such steps are performed in the same conditions as used in the preparation of organic toners, it is not possible to obtain toner having a sharp particle distribution. It has been found that the difficulty is attributed to a higher specific gravity of inorganic toner (generally 2.4-2.8) as compared with organic toner (generally 0.8-1.4).

In the case of organic toner, fine pulverization is carried out using a pulverizer in combination with a sieving device. In operation, the finely pulverized product obtained in the pulverizer is continuously fed to the succeeding sieving device where fractions having larger and smaller particle sizes are continuously separated. The larger particle size fraction is continuously recycled to the pulverizer.

When the above method is adopted in the preparation of inorganic toner, however, the sieving step is not smoothly carried out. Namely, random flows occur in the sieving step due to unbalanced relation between the centrifugal and centripetal forces. This results in failure to recycle a desired amount of larger particle size fraction to the pulverizer.

It has been unexpectedly found that when the coarse pulverization is carried out under such a condition that the coarsely pulverized mixture has a volume average particle diameter of 20-150 μm, inorganic toner free of white spots formation and uneven firing is obtainable in the succeeding fine pulverization and sieving with a high yield. It has also been found that the above method is also effective for the production of inorganic toner having a content of fine particles with a particle diameter of 5 μm or less of 45% by weight or less. The coarse pulverization is preferably carried out so that the coarsely pulverized mixture has a volume average particle diameter of 30-130 μm, more preferably 50-80 μm.

In the production of organic toner, coarse pulverization is generally performed to produce a pulverized product having a volume average particle diameter of about 400 μm. When such a condition is adopted for the production of inorganic toner, inorganic toner having satisfactory particle size is not obtainable with an acceptable yield.

The method of producing the inorganic toner according to the present invention will now be explained in more detail. A binder resin, a coloring agent and, optionally, a charge controlling agent and/or a releasing agent, in an appropriate mixing ratio, are sufficiently blended in a mixer such as a Henschel mixer or a ball mill, and thereafter the mixture is fused and kneaded, using a screw extruder type continuous kneader, a two-roll mill, a three-roll mill, or a pressure and heat application kneader.

The kneaded mixture is cooled and solidified, and then coarsely ground in a crusher such as a device using a rotary hammer or a combination of a rotor and stator with the aid of shear forces by air jet stream to improve the production yield. The use of a crusher provided with a screen mesh capable of controlling the particle size of the coarsely pulverized product or with a member capable of functioning as a classifier is preferred for reasons of easiness in particle size control.

The coarsely pulverized mixture is then finely pulverized. It is preferred that the finely pulverizing step be carried out using a device which has a collision plate and in which pulverization is effected with a jet stream of a compressed air or a device which has a rotor and a stator and in which pulverization is effected with shear by air stream.

If desired, the fine pulverization may be carried out in a two-step method including primary and secondary pulverization steps. The primary pulverization step generally uses a collision type pulverizer such as a hummer mill, a ball mill, a tube mill or an oscillating mill or a jet mill having a collision plate and compressed air. The secondary pulverization step preferably uses a rotor type mill having a stator and a rotor.

Preferably, the finely pulverized product is fed to a classifier for removing coarse particles contained therein and/or to a classifier for controlling a content of fine particles contained therein. The classifier may be a pneumatic conveying classifier or a mechanical classifier and is generally connected to the fine pulverizer.

The toner according to the present invention is used for forming a desired mono-color or full color pattern on a heat-resisting solid surface. The pattern can be formed by the following method. As the transfer sheet, a laminate having a support and a water-soluble layer, such as a dextrin or polyvinyl alcohol layer, formed thereon is used. A toner image is formed on the adhesive layer. The toner image on the adhesive layer is covered with a resin layer, such as a cellulose, acrylic resin or polystyrene resin layer, by for example coating. The transfer sheet is then immersed in water to dissolve the water soluble layer. The resin layer is peeled from the transfer layer. In this case, the toner image is transferred from the transfer sheet to the resin layer. The image-bearing resin layer is applied to an article having a heat-resisting surface, such as a tile, a glazed ceramic (e.g. a ceramic glass, a porcelain or a china), a heat-resisting glass, a metal or a porcelain enamel-coated metal, such that the toner image is in contact with the heat-resisting surface. Then the assembly is calcined or fired.

The apparatus for firing the toner image bearing heat-resistant solid is not particularly limited. In general, an electric oven or a gas oven is usable. The image can be formed at a position adjacent to the surface of the heat-resistant solid or somewhat deep from the surface thereof by controlling the sintering temperature.

Namely, to obtain an image on the surface portion of the heat-resistant solid, for instance, the temperature in an electric or gas oven is gradually increased from room temperature to 750 to 850° C. at a rate of 200° C./hour. The temperature is maintained at that temperature for 30 minutes to one hour. Thereafter, the oven is cooled to room temperature, and the image bearing heat-resistant solid is taken out of the oven. During the above-mentioned sintering step, the coloring agent contained in the toner is fixed to the surface portion of the heat-resistant solid by the action of the fritted glaze also contained in the toner. Thus, there can be obtained on the heat-resistant solid surface an image free of non-transferred white spots or uneven firing.

On the other hand, to obtain an image in an inner portion of the heat-resistant solid, for instance, the temperature in an electric or gas oven is gradually increased from room temperature to 1100 to 1300° C. at a rate of about 200° C./hour, and the temperature is maintained at 1100 to 1300° C. for 30 minutes to one hour. Thereafter, the oven is cooled to room temperature, and the image bearing heat-resistant solid is taken out of the oven.

There is a risk of the image bearing heat-resistant solid being cracked or deformed in the sintering step when the heat-resistant solid is subjected to rapid change of temperature. The occurrence ratio of such a risk slightly varies depending upon the thickness and the kind of heat-resistant solid. Therefore, it is preferable that the increase or decrease rate of temperature in the oven be in the range of 50 to 500° C./hour, more preferably 100 to 300° C./hour. When the increase or decrease rate of temperature is within the range of 50 to 500° C./hour, production efficiency is not lowered, and the heat-resistant solid can be fired uniformly without any deformation.

The following examples will further illustrate the present invention. Parts are by weight.

### EXAMPLE AND COMPARATIVE EXAMPLE

Preparation of Frit Glaze

A blend of metal oxides composed of 80 parts of Al₂O₃, 370 parts of SiO₂, 50 parts of Na₂O and 500 parts of PbO (hereinafter such a blend will be simply expressed as Al₂O₃/SiO₂/Na₂O/PbO of 80/370/50/500) was ground with a stamp mill and then mixed with a Henschel mixer. The mixture was then heat-treated at 1,200° C. to obtain a frit glaze (hereinafter referred to as Glaze A).

Preparation of Coloring Agents:

(A) Black Coloring Agent:

A blend of metal oxides Cr₂O₃/MnO/Fe₂O₃/CoO of 110/270/112/508 was ground with a stamp mill and then mixed with a Henschel mixer. The mixture was then heat-treated at 1,100° C. to obtain an oxide pigment (hereinafter referred to as Pigment A).

Pigment A (300 parts) was then mixed with 500 parts of Glaze A with a Henschel mixer and the mixture was calcined at 750° C. and ground to obtain a coloring agent (hereinafter referred to as Coloring Agent A).

(B) Yellow Coloring Agent:

A blend of metal oxides CuO/ZnO/Sb₂O₃ of 10/190/800 was ground with a stamp mill and then mixed with a Henschel mixer. The mixture was then heat-treated at 1,100° C. to obtain an oxide pigment (hereinafter referred to as Pigment B).

Pigment B (300 parts) was then mixed with 500 parts of Glaze A with a Henschel mixer and the mixture was calcined at 750° C. and ground to obtain a coloring agent (hereinafter referred to as Coloring Agent B).

(C) Magenta Coloring Agent:

A blend of metal oxides Fe₂O₃/NiO/CuO/Au₂O of 160/40/40/760 was ground with a stamp mill and then mixed with a Henschel mixer. The mixture was then heat-treated at 1,100° C. to obtain an oxide pigment (hereinafter referred to as Pigment C).

Pigment C (300 parts) was then mixed with 500 parts of Glaze A with a Henschel mixer and the mixture was calcined at 750° C. and ground to obtain a coloring agent (hereinafter referred to as Coloring Agent C).

(D) Cyan Compound Oxide Pigment:

A blend of metal oxides Cr₂O₃/Fe₂O₃/Co₂O₃/ZnO of 170/10/690/130 was ground with a stamp mill and then mixed with a Henschel mixer. The mixture was then heat-treated at 1,100° C. to obtain an oxide pigment (hereinafter referred to as Pigment D).

Pigment D (300 parts) was then mixed with 500 parts of Glaze A with a Henschel mixer and the mixture was calcined at 750° C. and ground to obtain a coloring agent (hereinafter referred to as Coloring Agent D).

Preparation of Toner:

230 Parts of each of Coloring Agents A-D, 100 parts of an epoxy resin (Tg: 60° C.) and 4 parts of zinc salicylate (Bontron E84 manufactured by Orient Chemical Inc.) were mixed with each other using a mixer and the mixture was kneaded with a two-roll kneader. The kneaded mixture was solidified, coarsely pulverized and then finely pulverized. The coarse pulverization was carried out with a shear-type rotary hammer pulverizer (Pulverizer manufactured by Hosokawa Micron Inc.) under different conditions so that 8 (eight) kinds of coarsely pulverized products having volume average particle diameters of 500, 400, 300, 150, 100, 50, 20 and 10 μm were prepared for each of Coloring Agents A-D. Each coarsely pulverized product was finely pulverized with a pulverizer (Jet Mill manufactured by Nippon Pneumatic Inc.) to obtain inorganic toner (Toner No. 1-8) whose particle size characteristics are summarized in Table 1.

TABLE 1

| Toner | | | | | | | | |
|---|---|---|---|---|---|---|---|---|
| No. | 1 *7 | 2 *7 | 3 | 4 | 5 | 6 | 7 | 8 |
| Volume | 500 | 400 | 300 | 150 | 100 | 50 | 20 | 10 |
| average | | | | | | | | |
| (μm) *1 | | | | | | | | |
| 16 μm ≧ | 47.3 | 22.4 | 19.7 | 8.4 | 7.4 | 5.3 | 4.6 | *6 |
| Content | | | | | | | | |
| (%) *2 | | | | | | | | |
| 5 μm ≦ | 45.2 | 37.2 | 7.3 | 23.8 | 20.5 | 21.8 | 25.3 | *6 |
| Content | | | | | | | | |
| (%) *3 | | | | | | | | |
| Volume | 9 | 9 | 9 | 9 | 9 | 9 | 9 | *6 |
| average | | | | | | | | |
| (μm) *4 | | | | | | | | |
| Roundness | 1.98 | 1.68 | 1.62 | 1.48 | 1.43 | 1.33 | 1.28 | *6 |
| *5 | | | | | | | | |

*1: volume average particle diameter of coarsely pulverized product
*2: content of coarse particles having a diameter of 16 μm or more in the toner
*3: content of fine particles having a diameter of 5 μm or less in the toner
*4: volume average particle diameter of the toner
*5: Dv/Dn
*6: unable to obtain
*7: comparative

Preparation of Carrier:

| | |
|---|---|
| Silicone resin (KR50 manufactured by Shinetsu Kagaku Inc.) | 100 parts |
| Carbon black (BP 2000 manufactured by Cabott Inc.) | 3 parts |
| Toluene | 100 parts |

The above composition was mixed with a mixer for 30 minutes to form a dispersion. The dispersion was charged into a fluidized bed-type coating device together with 1,000 parts of ferrite particles having an average particle diameter of 70 μm. The ferrite particles thus coated were dried to obtain Carrier A.

Preparation of Developers:

Each of Toner Nos. 1-7 was mixed with 1.3% by weight of hydrophobic silica (R972 manufactured by Japan Aerosil Inc.) using a mixer. The resulting mixture was further mixed with Carrier A using a ball mill for 15 minutes to obtain Developer Nos. 1-7 for each of black, yellow, cyan and magenta. The amount of toner in each developer was 20% based on the weight of the carrier.

The procedure for the preparation of Developer No. 6 was repeated in the same manner as described except that: in Developer No. 8, the amount of silica (additive) was decreased from 1.3% by weight to 0.25% by weight; in Developer No. 9, the amount of silica (additive) was increased from 1.3% by weight to 1.5% by weight; in Developer No. 10, the content of Toner No. 6 was decreased from 20% by weight to 2% by weight; in Developer No. 11, the content of Toner No. 6 was increased from 20% by weight to 30% by weight; and in Developer No. 12, toner was prepared using 100 parts of each Coloring Agent A-D and 230 parts of the epoxy resin (Tg: 60° C.).

Formation of Pattern on Tile:

A copy image was formed on a commercially available transfer sheet (OK Series sheet for stencil printing in the ceramic art; manufactured by Nitto Shiko Inc.; a laminate composed of a surface layer, an adhesive layer and a substrate) using each of Developers Nos. 1-12 charged in a copying machine (PRETER 650 manufactured by Ricoh Company, Ltd.) under the following conditions:

| | |
|---|---|
| Process speed: | 180 m/sec |
| Charging voltage: | −650 V |
| Exposure voltage: | −100 V to −500 V |
| Development bias: | −500 V |
| Belt transfer bias: | 1400 V to 1700 V |
| Paper transfer bias: | 900 V to 1500 V |

Gradient, background stains and image dust of the image formed on the transfer sheet were evaluated. The results are shown in Table 2.

The toner image-bearing surface of the transfer sheet was applied with a polystyrene resin coating. After the resin coating had been dried, the sheet was immersed in water to remove the substrate. The surface layer bearing the toner image was applied on a tile (RS252/1001 manufactured by INAX Inc.) and the assembly was heated at a rate of 100° C./hour to 800° C. and maintained at that temperature for 30 minutes. The tile was then allowed to cool to obtain a desired tile having a pattern corresponding to the toner image. White spots and uneven firing of the pattern on the tile were evaluated. The results are shown in Table 2.

The evaluation was made according to the following ratings:

A: excellent

B: good

C: fair

D: no good

E: worse

TABLE 2

| | | Before sintering | | | After | |
|---|---|---|---|---|---|---|
| | | | Back- | | sintering | |
| Toner | Developer | | ground | Image | White | Uneven |
| No. | No. | Gradient | stains | dust | spot | firing |
| 1* | 1* | E | A | B | E | E |
| 2* | 2* | E | A | C | E | D |
| 3 | 3 | C | B | C | B | C |
| 4 | 4 | D | D | D | C | B |
| 5 | 5 | C | C | C | B | C |
| 6 | 6 | A | A | A | A | A |
| 7 | 7 | B | B | B | A | A |
| 6 | 8 | B | B | B | B | C |
| 6 | 9 | B | A | B | C | B |
| 6 | 10 | A | B | A | B | C |
| 6 | 11 | B | A | B | B | C |
| 6′ | 12 | C | C | D | C | C |

*: comparative

Formation of Full Color Pattern on Tile:

A full color copy image was formed on a commercially available transfer sheet (OK Series sheet for stencil printing in the ceramic art; manufactured by Nitto Shiko Inc.; a laminate composed of a surface layer, an adhesive layer and a substrate) using the above cyan, magenta, yellow and black Developers No. 6 contained in toner containers mounted on a copying machine (PRETER 650 manufactured by Ricoh Company, Ltd.) under the conditions shown above. The toner image was transferred to a tile (RS252/1001 manufactured by INAX Inc.) and sintered in the same manner as above to obtain a decorated tile having a clear full color image free of white spots or uneven firing.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

The teachings of Japanese Patent Application No. 2000-076287, filed Mar. 17, 2000, inclusive of the specification and claims, are hereby incorporated by reference herein.

What is claimed is:

1. An inorganic toner providing a chromatic color upon being calcined and comprising an inorganic coloring agent, and a binder resin, wherein the content of coarse particles having a diameter of 16 μm or more in said inorganic toner is not greater than 20% by weight.

2. An inorganic toner as recited in claim 1, wherein the content of fine particles having a diameter of 5 μm or less in said inorganic toner is not greater than 45% by weight.

3. An inorganic toner as recited in claim 1, and having a volume average particle diameter of 3-15 μm.

4. An inorganic toner as recited in claim 1, and having a volume average particle diameter of Dv and a number average particle diameter of Dn, wherein the ratio of Dv/Dn is not greater than 1.4.

5. An inorganic toner as recited in claim 1, wherein said coloring agent is a pigment of a material comprising a plural kinds of metal elements which contribute to the color of said coloring agent.

6. An inorganic toner as recited in claim 1, wherein said coloring agent is an alloy pigment obtained by fusing a mixture containing a plural kinds of metals which contribute to the color of said coloring agent and/or a plural kinds of metal oxides comprising a plural kinds of metal elements which contribute to the color of said coloring agent at a temperature of 1,000 to 1,200° C., the fused mixture being subsequently cooled and ground.

7. An inorganic toner as recited in claim 1, wherein said coloring agent is a pigment of a material comprising a plural kinds of metal elements which contribute to the color of said coloring agent, and at least one kind of a metal element which does not contribute to the color of said coloring agent.

8. An inorganic toner as recited in claim 1, wherein said coloring agent is a pigment obtained by a method comprising fusing a mixture containing a plural kinds of metals which contribute to the color of said coloring agent and/or a plural kinds of oxides of metals which contribute to the color of said coloring agent at a temperature of 1,000 to 1,200° C., cooling and grinding the fused mixture to obtain an alloy pigment, blending said alloy pigment with a glaze frit, fusing the blend at a temperature of 650 to 800° C., and cooling and grinding the fused blend.

9. An inorganic toner as recited in claim 5, wherein said metal elements which contribute to the color of said coloring agent are selected from the group consisting of Cu, Ag, Au, Cd, Ti, V, Sb, Se, Cr, Mo, W, U, Mn, Fe, Co, Ni, Ir and Pt.

10. An inorganic toner as recited in claim 1, wherein said inorganic coloring agent is present in an amount greater than the weight of said binder resin.

11. An inorganic toner as recited in claim 1, additionally containing an additive in an amount of 0.3-1.3% based on the weight of said toner.

12. An inorganic toner as recited in claim 1, and affording a toner image with a color of cyan, magenta, yellow or black.

13. A two-component developer comprising an inorganic toner according to claim 1, and a carrier, said toner being present in an amount of 5-27% based on the weight of the carrier.

14. A toner container accommodating a two-component developer according to claim 13.

15. An image forming device comprising a toner container according to claim 14.

16. An image forming device according to claim 15, comprising four toner containers containing inorganic toners according to claim 1 providing toner images having cyan, magenta, yellow and black, respectively, so that said device can form a full color image.

17. A method of forming an image, comprising developing a latent image with a two-component developer according to claim 13.

18. A method of producing an inorganic toner developing a color when calcined, comprising the steps of:
kneading a mixture containing an inorganic coloring agent and a binder resin,
coarsely pulverizing the kneaded mixture such that the pulverized mixture has a volume average particle diameter of 20-150 μm,
finely pulverizing the coarsely pulverized mixture, and
sieving the ground mixture.

19. A method as claimed in claim 18, wherein the coarsely pulverizing step is carried out while controlling the particle size of the coarsely pulverized mixture with a screen mesh or a sieving device.

20. A method as claimed in claim 18, wherein said finely pulverizing step is carried out using a device which has a collision plate and in which pulverization is effected with a jet stream of a compressed air or a device which has a rotor and a stator and in which pulverization is effected with shear by air stream.

21. A method as claimed in claim 18, wherein the finely pulverized product is fed to a classifier for removing coarse particles contained therein.

22. A method as claimed in claim 18, wherein the finely pulverized product is fed to a classifier for controlling a content of fine particles contained therein.
